(19) United States
(12) Patent Application Publication
(10) Pub. No.: US 2019/0003331 A1
(43) Pub. Date: Jan. 3, 2019

(54) SYSTEM FOR MOUNTING A VIBRATION SENSOR ONTO A MACHINE

(71) Applicant: Solar Turbines Incorporated, San Diego, CA (US)

(72) Inventors: Jena Le Neuman, San Diego, CA (US); Michael Lawrence Samuelian, Encinitas, CA (US); Kwok-Kwong Ben Tse, San Diego, CA (US); Varadharajan Sampathkumar, San Diego, CA (US)

(21) Appl. No.: 15/635,303

(22) Filed: Jun. 28, 2017

(51) Int. Cl. F01D 17/02

(52) U.S. Cl. CPC F01D 17/02; F05D 2260/96

(57) ABSTRACT

A system for mounting at least one vibration sensor onto a machine includes a mounting block that is funned from a pre-determined material and of a form such that the pre-determined material and form of the mounting block render the mounting block with a natural frequency lying at least 1500 Hertz (Hz) away from a range of frequencies associated with operation of the machine.

### TECHNICAL FIELD

The present disclosure relates to a system for mounting a sensor onto a machine. More particularly, the present disclosure relates to a system for mounting a vibration sensor onto a machine.

### BACKGROUND

Many types of machines are known to experience vibrations during operation. For instance, an engine operating under specific load and speed conditions may experience vibrations that are in harmonic resonance with a natural frequency of the engine itself. Operation under such conditions may cause one or more detrimental effects including, but not limited to, a failure of one or more components associated with the engine.

In order to operate such machines smoothly and avoid detrimental effects caused due to vibrations, it may be required to diagnose the cause of vibrations. A preliminary step to identifying the source of vibrations may include determining a magnitude of vibrations using a vibration sensor so that signatures s of vibrations can be monitored to help identify the source of vibrations. Typically, these vibration sensors have been mounted onto machines using conventional mounting systems. Such conventional mounting systems may be configured improperly and hence, tend to vibrate harmonically with the machine owing to an interference between natural frequencies of the machine and the conventional mounting system. Therefore, with use of such conventional mounting systems, readings obtained from the vibration sensor may become inaccurate.

Hence, there is a need for a mounting system that obviates harmonic vibrations with the machine itself so that accurate readings can be obtained from one or more vibration sensors mounted onto the machine using the mounting system.

### SUMMARY OF DISCLOSURE

In an aspect of the present disclosure, a system for mounting at least one vibration sensor onto a machine is provided. The system includes a mounting block that is formed from a pre-determined material and having a form such that the pre-determined material and form of the mounting block render the mounting block with a natural frequency lying at least 1500 Hertz (Hz) away from a range of frequencies associated with operation of the machine. In an additional aspect of this disclosure, the pre-determined material may include a 410 Grade Stainless Steel per ASTM A479 Martensitic Grade Condition 2 or 3, or a 410 Stainless Steel per ASTM A276 Condition H (hardened and tempered at a pre-determined relatively low temperature).

In an aspect of the present disclosure, the mounting block is configured to define a mounting surface fir facilitating a mounting of the at least one vibration sensor thereon. Also, the :mounting block includes a hole that extends through a pair of opposing sidewalk in which at least one of the opposing sidewalk is located adjacent to the mounting surface. Additionally, the system includes a securement system that is configured to engage with the hole for securing the mounting block to the machine. The securement system includes a washer located on one of the opposing sidewalls and disposed about the hole. Further, the securement system also includes a fastener that is received within a hole defined by the washer and the hole of the mounting block. The fastener would be configured to engage with a threaded receptacle located on the machine.

In another aspect of the present disclosure, a system for mounting at least one vibration sensor onto a machine is disclosed. The system includes a mounting block having a first portion, a mid-wall, and a second portion. The first portion has a mounting surface defining a first set of threaded receptacles and a second threaded receptacle. The first portion also includes a first set of sidewalls that extends laterally from the mounting surface, and a second set of sidewalls that are configured to extend partway along a height of the mounting block. The mid-wall is disposed parallel to and in a spaced apart relation to the mounting surface in which an area of the mid-wall is less than an area of the mounting surface. The second portion is disposed partway along a perimeter of the first portion excluding the mid-wall. The second portion includes a plurality of third sidewalls that extend from one or more of the first sidewalls from the first portion. The second portion also includes a pair of beveled surfaces that extend laterally from at least one of the third sidewalls and is joined with an end wall that is parallel to each of the mounting surface and the mid-wall.

In another aspect of the present disclosure, a method for mounting at least one vibration sensor onto a machine includes providing a mounting block that is formed from a pre-determined material and having a form such that the pre-determined material and form of the mounting block render the mounting block with a natural frequency lying at least 1500 Hertz (Hz) away from a range of frequencies associated with operation of the machine. The method also includes engaging a securement system with a hole extending through a pair of opposing sidewalls of the mounting block for securing the mounting block to the machine.

Other features and aspects of this disclosure will be apparent from the following description and the accompanying drawings.

### BRIEF DESCRIPTION OF THE DRAWINGS

FIG. 1 is an aft view of a system for mounting a pair of vibration sensors onto a machine, in accordance with an embodiment of the present disclosure;

FIG. 2 is an exploded top/aft perspective view of the system showing a mounting block and a securement system, in accordance with an embodiment of the present disclosure;

FIG. 3 is a bottom-left side perspective view of the system showing a mounting surface, in accordance with an embodiment of the present disclosure;

FIG. 4 is a top view of the system shown in an assembled state, in accordance with an embodiment of the present disclosure;

FIG, 5 is a top-aft perspective view of the system, in accordance with an embodiment of the present disclosure; and

FIG. 6 is a flowchart depicting a method for mounting the pair of vibration sensors onto the machine, in accordance with an embodiment of the present disclosure.

### DETAILED DESCRIPTION

Reference numerals appearing in more than one figure indicate the same or corresponding parts in each of them. References to elements in the singular may also be construed to relate to the plural and vice-versa without limiting the scope of the disclosure to the exact number or type of such elements unless set forth explicitly in the appended claims.

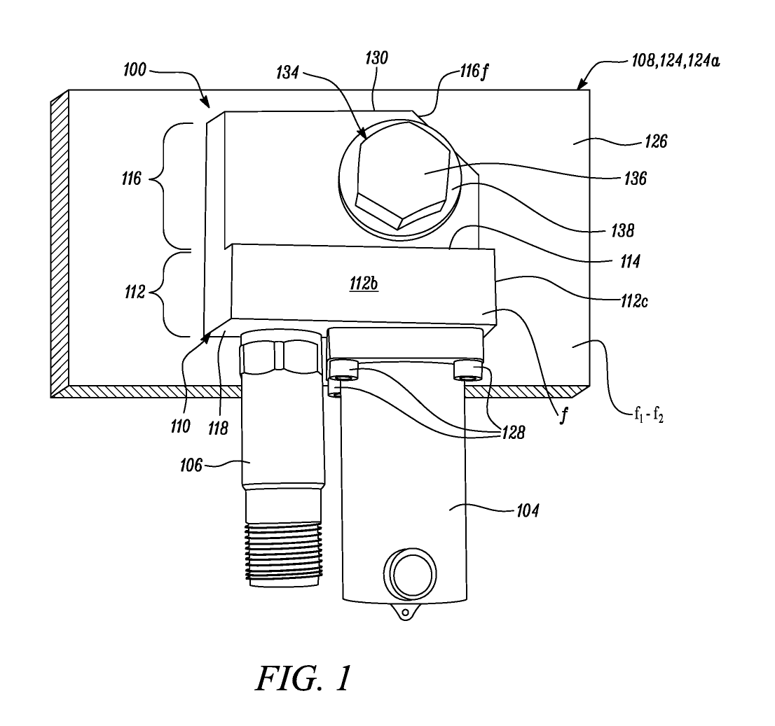

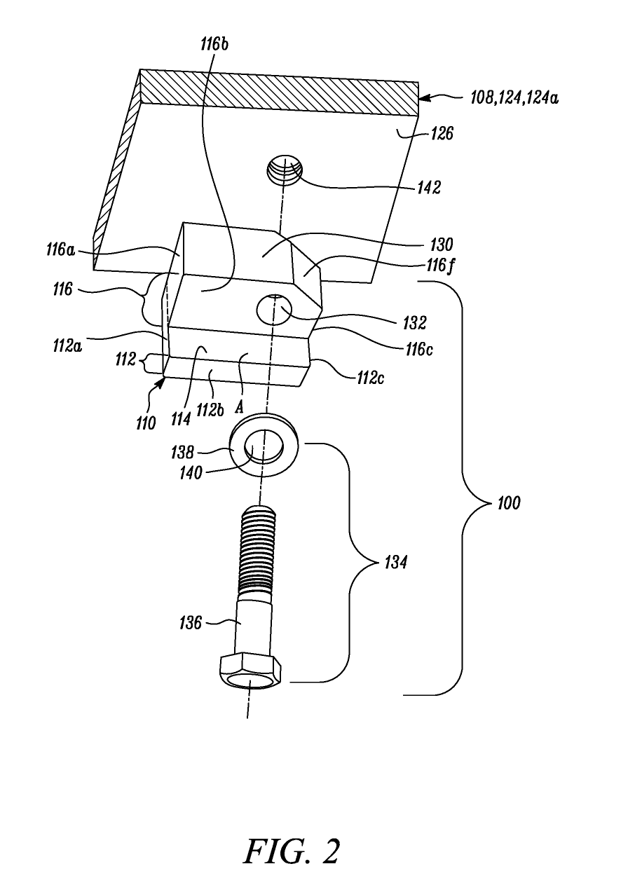

FIGS. 1-2 illustrate assembled and exploded views of a system 100 for mounting a pair of vibration sensors 104, 106 (shown in FIG. 1) onto a machine 108. Although the pair of vibration sensors 104, 106 is depicted in the illustrated embodiment of FIG. 1, it may he noted that the pair of vibration sensors 104, 106 is non-limiting of this disclosure. In other embodiments, fewer or more vibration sensors, for example, one, three, four, or five vibration sensors may be mounted onto the machine 108 depending on specific requirements of an application.

In an example, the vibration sensor 104 may include a velocity transducer while the vibration sensor 106 may include an accelerometer. Although a velocity transducer and an accelerometer are disclosed herein, it should be noted that the velocity transducer and the accelerometer are non-limiting of this disclosure. Rather, it will be appreciated that the system 100 of the present disclosure can be used to mount any type of vibration sensors, in lieu of the velocity transducer and the accelerometer disclosed herein, fir measuring vibrations from the machine 108.

In an embodiment, the machine 108 disclosed herein may be a prime mover 124 which could include an engine or an electric motor. For instance, in the embodiment depicted in FIG. 1, the prime mover 124 may be a gas turbine engine 124a having a housing which is denoted by numeral ‘126’. Although different types of prime movers are disclosed herein, it may be noted that the machine 108 could include various other structures other than prime movers. Therefore, it will be appreciated that the use of the system 100 disclosed herein is not limited to facilitating mounting of vibration sensors 104, 106 onto a prime mover, rather the system 100 of the present disclosure can be used to mount the vibration sensors 104, 106 onto any type of structure known in the art that experiences vibrations during operation and, for which, measurement is required.

As shown in FIGS. 1-5, the system 100 includes a mounting block 110. In embodiments herein, the mounting block 110 is formed from a pre-determined material and has a form such that the pre-determined material and form of the mounting block 110 render the mounting block 110 with a natural frequency, f, lying at least 1500 Hertz (Hz) away from a range of frequencies f₁ through f₂ associated with operation of the machine 108. That is, the natural frequency f of the mounting block 110 lies outside of the range of operational frequencies f₁ through f₂ associated with the machine 108 by at least 1500 Hz i.e., f-f₁≥1500 Hz and f₂-f≥1500 Hz.

Further, in embodiments disclosed herein, the material used to form the mounting block 110 may include a 410 Grade Stainless Steel per ASTM A479 Martensitic Grade Condition 2 or 3, or a 410 Stainless Steel per ASTM A276 Condition H (hardened and tempered at a pre-determined relatively low temperature). The form of the mounting block 110, together with the material of the mounting block 110, helps render the mounting block 110 with the natural frequency f, at least 1500 Hz away from frequencies f₁ through f₂ as will be explained hereinafter.

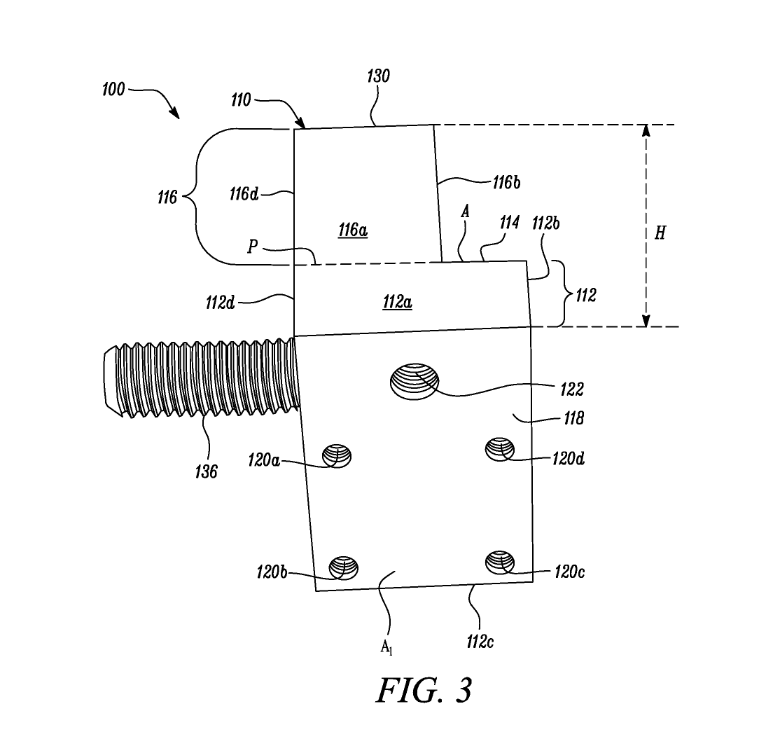

As shown in FIGS. 1-5, the mounting block 110 is configured to include a first portion 112, a mid-wall 114, and a second portion 116. As shown best in FIG. 3, the first portion 112 has a mounting surface 118 defining a first set of threaded receptacles 120a-120d and a second threaded receptacle 122. The first set of threaded receptacles 120a-120d could be used to facilitate a mounting of the vibration sensor 104 with the help of fasteners 128, for example, Allen screws, as Shown in FIG. 1. The second threaded receptacle 122 could be used to secure the vibration sensor 106 using another fastener, for instance, a grub screw (not shown) associated with the vibration sensor 106 itself.

Referring to FIGS. 1-5, the first portion 112 also includes a first set of sidewalls 112a-112d that extend laterally from the mounting surface 118 in which a portion of the sidewalls 112a, 112b and the sidewall 112c is configured to extend partway along a height H of the mounting block 110. The mid-wall 114 is disposed parallel to and in a spaced apart relation to the mounting surface 118 in which an area A of the mid-wall 114 is less than an area A₁ of the mounting surface 118 (refer to FIGS. 2 and 3).

The second portion 116 is disposed partway along a perimeter P of the first portion 112 excluding the mid-wall 114. The second portion 116 includes a plurality of third sidewalls 116a-116d. The third sidewalk 116a, 116c, and 116d extend from respective ones of the first sidewalls 112a, 112c, and 112d of the first portion 112 while another one of the third sidewalls 116b extends from the mid-wall 114 respectively. The second portion 116 also includes a pair of beveled surfaces 116e, 116f that extend angularly from corresponding ones of the third sidewalk 116d, 116c. Each of these beveled surfaces 116e-116f is joined with an end wall 130 of the mounting block 110 that is disposed parallel to each of the mounting surface 118 and the mid -wall 114 respectively.

The mounting block 110 defines a hole 132 that extends through a pair of opposing third sidewalk 116b, 116d. As shown, the system 100 includes a securement system 134 that is configured to engage with the hole 132 for securing the mounting block 110 to the machine 108, for instance, with the housing 126 of the gas turbine engine 124a.

In an embodiment as shown in FIGS. 1-5, the securement system 134 includes a washer 138 that is located on one of the opposing sidewalls 116b and disposed about the hole 132. The securement system also includes a fastener 136 that is received within a hole 140 defined by the washer 138 and the hole 132 of the mounting block 110. The fastener 136 is configured to engage with a threaded receptacle 142 located on the machine 108, for instance, on the housing 126 of the gas turbine engine 124a as shown in FIG. 2. As shown in the illustrated embodiment of FIGS. 1-5, the fastener 136 may include a HEX bolt. However, in other embodiments, other types of fasteners including, but not limited to, an Allen screw, a grub screw, or other types of fasteners may be used in lieu of the HEX bolt disclosed herein.

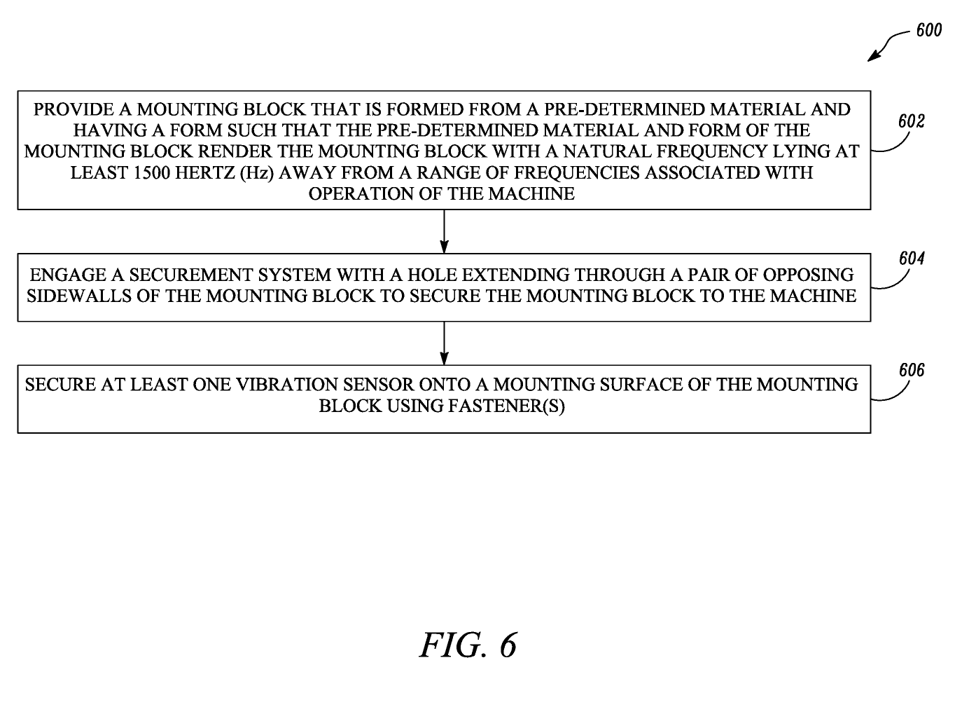

FIG. 6 illustrates a method 600 for mounting at least one vibration sensor 104 and/or 106 onto the machine 108. At step 602, the method 600 includes providing a mounting block 110 that is formed from a pre-determined material and having a form such that the pre-determined material and form of the mounting block 110 render the mounting block 110 with a natural frequency lying at least 1500 Hz away from a range of frequencies f₁-f₂ associated with operation of the machine 108.

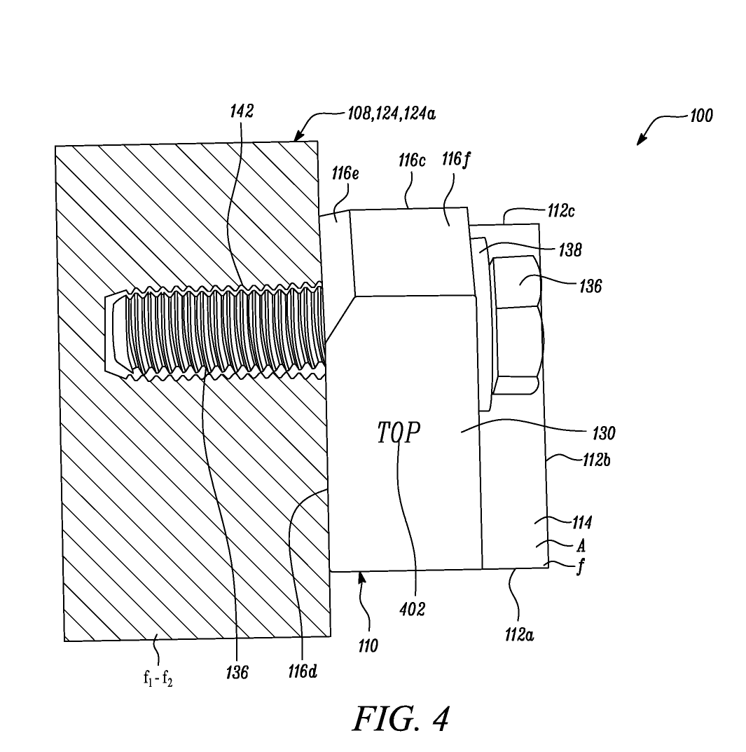

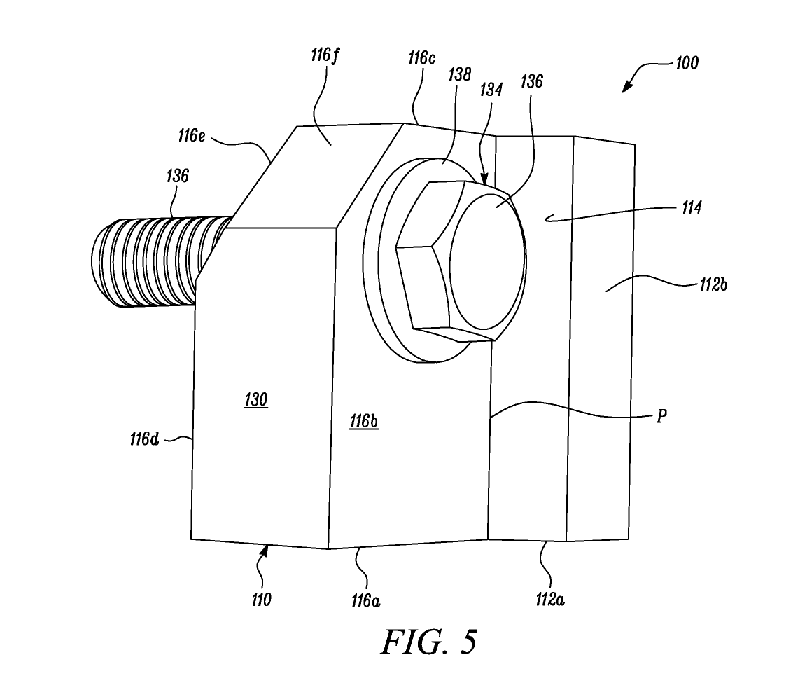

At step 604, the method 600 also includes engaging a securement system 134 with a hole 132 extending through a pair of opposing sidewalls 116b, 116d of the mounting block 110 for securing the mounting block 110 to the machine 108. As disclosed earlier herein, in an embodiment as shown in FIGS. 2-5, the securement system 134 includes a washer 138 that is located on one of the opposing sidewalls 116b and disposed about the hole 132. The securement system also includes a listener 136 that is received within a hole 140 defined by the washer 138 and the hole 132 of the mounting block 110. As shown best in FIG. 4, the fastener 136 is engaged with a threaded receptacle 142 located on the machine 108.

As further shown in FIG.4, the system 100 can be provided with orientation indicia 402 such as the orientation indicia 402 shown for exemplary purposes on the mounting block 110 in FIG. 4. Such a showing is for exemplary purposes and the present invention contemplates the use of the orientation indicia 402 on other portions of the system 100, as well as the simultaneous use of orientation indicia 402 on multiple locations of the mounting block 110. The orientation indicia 402 can consist of words such as “TOP” as shown in FIG. 4, orientation symbols such as arrows, or a combination of words and symbols.

At step 606, the method 600 also includes securing the at least one vibration sensor, for instance, vibration sensor 104 onto the mounting surface 118 of the mounting block 110 using at least one fastener, for instance, the fasteners 128 (as shown in FIG. 1). Similar or another manner of securement can be used to secure other vibration sensors known in the art. For instance, the vibration sensor 106, as shown in FIG. 1, could be secured to the mounting surface 118 using a fastener that is integrally held by a body of the vibration sensor 106 itself

Various embodiments disclosed herein are to be taken in the illustrative and explanatory sense, and should in no way be construed as limiting of the present disclosure. All joinder references (e.g., attached, affixed, coupled, engaged, meshed, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, or any other ordinary and/or numerical terms, should also be taken only as identifiers, to assist the reader's understanding of the various elements, embodiments, variations and/ or modifications of the present disclosure, and may not create any limitations, particularly as to the order, or preference, of any element, embodiment, variation and/or modification relative to or over another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

Embodiments of the present disclosure have applicability for use and implementation in mounting one or more vibration sensors onto a machine, With use of the system 100 disclosed herein, harmonic vibration of the mounting block together with the machine 108 can be prevented to allow accurate measurement readings from the vibration sensors 104, 106 mounted onto the machine 108.

Moreover, a form of the mounting block 110 is polygonal and asymmetrical, as shown in FIGS. 1-5. This polygonal and asymmetrical form of the mounting block 110, together with the pre-determined materials/s used to form the mounting block 110, offsets the natural frequency f of the mounting block 110 and the range of operational frequencies f₁-f₂ associated with the machine 108. Hence, the mounting block 110 would not be able to resonate under the effect of vibrations during operation of the machine 108. Therefore, the system 100 of the present disclosure helps technicians to obtain accurate measurements from each of the vibration sensors 104, 106 that in turn would help diagnose faults, if any, with one or more components of the machine 108.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A system for mounting at least one vibration sensor onto a machine, the system comprising:
a mounting block formed from a pre-determined material and having a form such that the pre-determined material and form of the mounting block render the mounting block with a natural frequency lying at least 1500 Hertz (Hz) away from a range of frequencies associated with Operation of the machine.

2. The system of claim 1, wherein the pre-determined material includes at least one of: a 410 Grade Stainless Steel per ASTM A479 Martensitic Grade Condition 2 or 3, and a 410 Stainless Steel per ASTM A276 Condition H.

3. The system of claim 1, wherein the mounting block is configured to define a mounting surface for facilitating a mounting of the at least one vibration sensor thereon.

4. The system of claim 3, wherein the mounting block includes a hole that extends through a pair of opposing sidewalls, at least one of the opposing sidewalls being located adjacent to the mounting surface.

5. The system of claim 4 further comprising a securement system that is configured to engage with the hole far securing the mounting block to the machine.

6. The system of claim 5, wherein the securement system includes:
a washer located on one of the opposing sidewalk and disposed about the hole; and
a fastener received within a hole defined by the washer and the hole of the mounting block, the fastener configured to engage with a threaded receptacle located on the machine.

7. A system for mounting at least one vibration sensor onto a machine, the system comprising:
a mounting block comprising:
a first portion having a mounting surface defining a first set of threaded receptacles and a second threaded receptacle, and a first plurality of sidewalls extending laterally from the mounting surface, and a second plurality of sidewalls configured to extend partway along a height of the mounting block; and
a mid-wail disposed parallel to and in a spaced apart relation to the mounting surface, wherein an area of the mid-wall is less than an area of the mounting surface; and
a second portion disposed partway along a perimeter of the first portion excluding the mid-wall, the second portion including:
a plurality of third sidewalk that extend from one or more of the first sidewalk from the first portion, and a pair of beveled surfaces extending angularly from at least one of the third sidewalls and joined with an end wall that is parallel to each of the mounting surface and the mid-wall.

8. The system of claim 7, wherein the mounting block is formed from a pre-determined material and has a form such that the pre-determined material and form of the mounting block render the mounting block with a natural frequency lying at least 1500 Hertz (Hz) away from a range of frequencies associated with operation of the machine.

9. The system of claim 8, wherein the pre-determined material includes at least one of: a 410 Grade Stainless Steel per ASTM A479 Martensitic Grade Condition 2 or 3, and a 410 Stainless Steel per ASTM A276 Condition H.

10. The system of claim 7, wherein the mounting surface is configured to facilitate a mounting of the at least one vibration sensor thereon.

11. The system of claim 7, wherein the mounting block includes a hole that extends through a pair of opposing sidewalls from the plurality of third. sidewalls.

12. The system of claim 11 further comprising a securement system that is configured to engage with the hole for securing the mounting block to the machine.

13. The system of claim 12, wherein the securement system includes:
a washer located on one of the opposing sidewalk and disposed about the hole; and
a fastener received within a hole defined by the washer and the hole of the mounting block, the fastener configured to engage with a threaded receptacle located on the machine.

14. A prime mover having:
a housing, and
employing the system of claim 7 to mount the at least one sensor onto the housing of the prime mover.

15. The prime mover of claim 14, wherein the prime mover includes an engine.

16. The prime mover of claim 15, wherein the engine is a gas turbine engine.

17. A method for mounting at least one vibration sensor onto a machine, the method comprising:
providing a mounting block that is formed from a pre-determined material and having a form such that the pre-determined material and form of the mounting block render the mounting block with a natural frequency lying at least 1500 Hertz (Hz) away from a range of frequencies associated with operation of the machine; and
engaging a securement system with a hole extending through a pair of opposing sidewalls of the mounting block for securing the mounting block to the machine; and
securing the at least one vibration sensor onto a mounting surface of the mounting block using at least one fastener.

18. The method of claim 17, wherein the securement system includes:
a washer located on one of the opposing sidewalls and disposed about the hole; and
a fastener received within a hole defined by the washer and the hole of the mounting block, the fastener configured to engage with a threaded receptacle located on the machine.

19. The method of claim 18, wherein the mounting block includes orientation indicia to assist in properly orientating the mounting block on the machine.

20. The method of claim 18, wherein the mounting surface is disposed adjacent to the pair of opposing sidewalls and is configured to define a first set of threaded receptacles and a second threaded receptacle thereon.
